(19) United States
(12) Patent Application Publication
(10) Pub. No.: US 2011/0205262 A1
(43) Pub. Date: Aug. 25, 2011

(54) PROCESS FOR PREPARING INK JET INKS

(75) Inventors: Michael Stephen Wolfe, Wilmington, DE (US); Scott Paap, Pleasanton, CA (US); Jefferson Tester, Hingam, MA (US)

(73) Assignees: E. I. DU PONT DE NEMOURS AND COMPANY, Wilmington, DE (US); MASSACHUSETTS INSTITUTE OF TECHNOLOGY, Cambridge, MA (US)

(21) Appl. No.: 13/126,508

(22) PCT Filed: Nov. 19, 2009
(86) PCT No.: PCT/US2009/065134

§ 371 Date: Apr. 28, 2011

Related U.S. Application Data
(60) Provisional application No. 61/199,641, filed on Nov. 19, 2008.

(51) Int. Cl. B41J 29/38; C09D 11/10

(52) U.S. Cl. 347/5; 524/364

(57) ABSTRACT

The present invention pertains to process for preparing an aqueous inkjet inks and more particularly to a process for using a milling device with a compatible solvent, a pigment and a polymeric dispersant. While milling a fluid is added to increase the pressure in the mill leading to a dispersion of the pigment with a polymeric dispersant. The polymerically dispersed pigment is then mixed into an aqueous media.

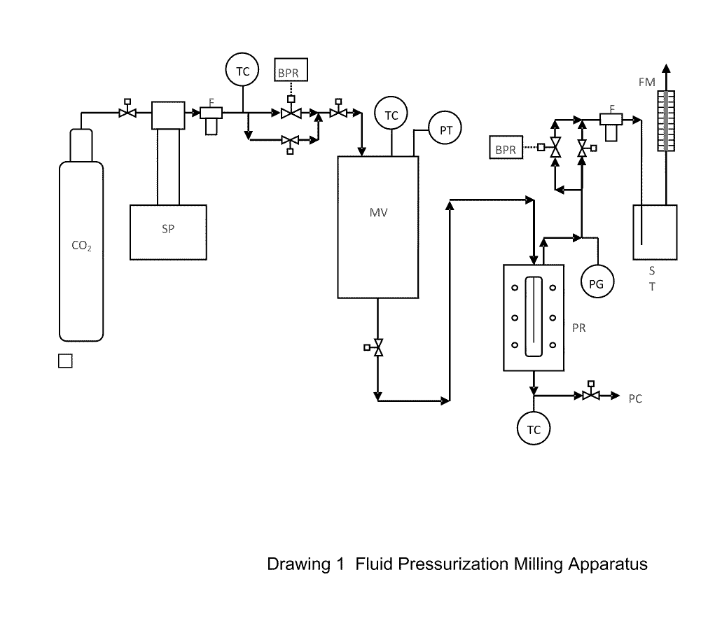

This application claims priority under 35 U.S.C. §119 from U.S. Provisional Application Ser. No. 61/199,641, filed Nov. 19, 2008.

### FIELD OF THE INVENTION

The present invention pertains to processes for preparing aqueous inkjet inks and more particularly to a process for using a milling device with a compatible solvent, a pigment and a polymeric dispersant. While milling, a fluid is added to increase the pressure in the mill leading to a dispersion of the pigment with a polymeric dispersant which is later mixed into an aqueous media. This fluid pressurization milling can produce polymeric dispersions which are difficult to obtain with other dispersion processes.

### BACKGROUND OF THE INVENTION

Ink jet printing is a non-impact method that produces droplets of ink which are deposited on a substrate such as paper, textiles etc in response to a digital signal. Ink jet printers, especially thermal or bubble jet drop-on-demand printers, have found broad application as output for personal computers in the office and the home. Thermal ink jet printers use a plurality of nozzles, each containing a resistor element, to fire ink droplets toward the print media. Nozzle openings are typically about 40-60 micrometers in diameter. For proper operation of the printer, it is imperative that the ink jet ink not clog or plug these small openings. For pigmented ink jet inks in particular, it is necessary that the pigment particles be of small enough particle size so as to not clog the ejection orifice in the nozzle. Small pigment particles are also advantageous because they are less prone to settling during storage. Pigment particles start in an agglomerated or flocculated state. Thus, it is necessary to disperse and stabilize the pigment so as to prevent flocculation and settling. The quality of the pigment dispersion may also affect some ink jet printing characteristics such as ejectability, print quality, optical density, and other ink jet properties. Ink jet inks have been made using different dispersion processes.

U.S. Pat. No. 5,026,427 teaches the use of a liquid jet interaction chamber in the preparation of pigmented ink jet inks. U.S. Pat. No. 5,085,698 teaches the preparation of aqueous pigmented inks for ink jet printers using a media mill, a ball mill, an attritor, or a liquid interaction chamber. U.S. Pat. No. 4,597,794 teaches the preparation of pigmented ink jet inks by ball mill, roll-mill, speed line mill, homomixer, sand grinder, and the like. T. C. Patton, “Paint Flow and Pigment Dispersion”, John Wiley & Sons, N.Y., N.Y., p. 386 (1979) discloses that a variety of different processes can be used to disperse pigments. These include ball and pebble mills, high speed disk impellers, high speed impingement mills, three-roll mills, high speed stone and colloid mills, sand mills, and batch attritors. US 2003/0089277 describes the use of cubic media to obtain dispersed pigments suitable for ink jet inks.

U.S. Pat. Appl. 2007/0020407 teaches a variety of dispersing options including a phase reversal emulsion that is claimed to give a microencapsulated pigment-containing aqueous dispersion.

Supercritical fluid processing has also been presented as an option to obtain particles with polymeric dispersants. These processes normally utilize the RESS (Rapid Expansion of Supercritical Solutions) to obtain the product (“Particle Formation with Supercritical Fluids” J. Aerosol Sci (1991) 22:555-584.) Japanese unexamined application JP1999197494 describes this process utilizing polymers like silicon resin, polyurethane, polyester, polybutadiene, polymethylmethacrylate or other acrylic acid ester, polystyrene for coating particles under supercritical conditions.

Still there are needs for different aqueous pigments with polymeric dispersants to satisfy the changing needs for ink jet inks. These new needs include the new requirements for Page Wide Array printing, newsprint and similar magazine printings. Inks must be more robust to tolerate the new jetting conditions and still achieve the colors and image distinctness.

### SUMMARY OF THE INVENTION

It has been found that if a pigment, a polymeric dispersant and a compatible solvent is milled while increasing the pressure in the mill a dispersed pigment can be obtained. The pressure in the mill is accomplished by adding a fluid to the mill. This fluid is one that can achieve supercritical properties at achievable pressures and temperatures. Thus, in one aspect of the invention there is provided a method for preparing an pigment dispersion comprising the steps of

(a) charging a milling device with a mixture of a pigment, a polymeric dispersant and one or more compatible solvents,

(b) milling the mixture, while introducing into the milling device a fluid and increasing the pressure in the milling device with the fluid to at least 0.2 of the Pᵣ and up to 1.25 Pᵣ of the fluid at from 0.5 to 1.5 of the Tᵣ of the fluid, where the fluid can behave as a supercritical fluid

(c) milling to obtain a dispersion of pigment with polymeric dispersant, and

(d) alternatively mixing the pigment dispersion of step (c) into an aqueous medium; and

wherein both the Pᵣ and Tᵣ are calculated based only on the fluid.

Steps (a), (b), and (c) can collectively be called a fluid pressurization process.

The fluids that may be used for this process are those commonly associated with fluids that can be used in their supercritical state. These fluids include carbon dioxide, methane, ethane, ethylene, propane propylene, butane, acetic acid, nitrous oxide, and ammonia. The solvent used must at least partially dissolve the polymeric dispersant. The mill used must be capable of the pressures required or capable of being modified for the pressures required.

In accordance with another embodiment of the fluid pressurization process, there is provided an aqueous pigmented ink jet ink comprising an aqueous pigment dispersion made by the fluid pressurization process and step (d) the conversion of the pigment dispersion to an aqueous system. described above, having from about 0.1 to about 30 wt % pigment based on the total weight of the ink, a weight ratio of pigment to dispersant of from about 0.5 to about 6, a surface tension in the range of about 20 dyne/cm to about 70 dyne/cm at 25° C., and a viscosity of lower than about 30 cP at 25° C.

In still another embodiment of the present invention, there is provided an ink set comprising at least one cyan ink, at least one magenta ink and at least one yellow ink, wherein at least one of the inks is an aqueous pigmented ink jet ink as set forth above and described in further detail below.

In yet another aspect of the present invention, there is provided a method for ink jet printing onto a substrate, comprising the steps of:

(a) providing an ink jet printer that is responsive to digital data signals;

(b) loading the printer with a substrate to be printed;

(c) loading the printer with an ink as set forth above and described in further detail below, or an ink jet ink set as set forth above and described in further detail below; and

(d) printing onto the substrate using the ink or inkjet ink set in response to the digital data signals.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### BRIEF DESCRIPTION OF DRAWINGS

The drawing shows a schematic for processing the pigment dispersion. In this schematic the fluid used is carbon dioxide. The system components are labeled in the drawing: carbon dioxide supply (CO₂), syringe pump (SP), back-pressure regulator (BPR), milling vessel (MV), particle recovery vessel (PR), filters (F), solvent trap (ST), flow meter (FM), particle collection (PC), thermocouple (TC), pressure transducer (PT), pressure gauge (PG).

### DETAILED DESCRIPTION

Unless otherwise stated or defined, all technical and scientific terms used herein have commonly understood meanings by one of ordinary skill in the art to which this invention pertains.

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “supercritical fluid” means a dense gas that is maintained above its critical temperature (the temperature above which it cannot be liquefied by pressure).

As used herein, the term “fluid” means any material or substance that changes shape or direction uniformly in response to an external force imposed on it.

As used herein, the term “critical pressure” means the critical pressure of a substance is the pressure required to liquefy a gas at its critical temperature.

As used herein, the term “reduced pressure, Pᵣ” means the reduced pressure of a fluid is defined as its actual pressure p divided by its critical pressure.

As used herein, the term “critical temperature” means critical temperature of a substance is the temperature at and above which vapor of the substance cannot be liquefied, no matter how much pressure is applied.

As used herein, the term “reduced temperature, Tᵣ” means the reduced temperature of a fluid at its actual temperature, divided by its critical temperature where the actual temperature and critical temperature are expressed in absolute temperature scale in ° Kelvin.

As used herein, the term “mill” means a unit operation which breaks pigment particles into smaller particles, and in this context is most often done with polymeric dispersants presents to produce a polymerically dispersed pigment.

As used herein, the term “milling device” means a piece of equipment where milling (or dispersing) takes place.

As used herein, the term “HPMM” means High Pressure Media Mill, especially as described in U.S. Pat. No. 7,152,819.

As used herein, the term “dispersion” means a two phase system where one phase consists of finely divided particles (often in the colloidal size range) distributed throughout a bulk substance, the particles being the dispersed or internal phase and the bulk substance the continuous or external phase. The bulk system is often an aqueous system.

As used herein, the term “pigment” means any substance usually in a powder form which imparts color to another substance or mixture. Additionally disperse dyes, white and black pigments are included in this definition.

As used herein, the term “HSD” means High Speed Dispersing.

As used herein, the term “aqueous vehicle” refers to water or a mixture of water and at least one water-soluble organic solvent (co-solvent).

As used herein, the term “d50” means the particle size at which 50% of the particles are smaller; “d95” means the particle size at which 95% of the particles are smaller.

As used herein, the term “neutralizing agents” means to embrace all types of agents that are useful for converting ionizable groups to the more hydrophilic ionic (salt) groups.

The process of preparing aqueous pigmented ink jet inks according to the present invention comprises the steps of:

(a) charging a milling apparatus with a mixture of a pigment, a polymeric dispersant one or more compatible solvents for the polymeric dispersant;

(b) milling the mixture, while introducing into the milling device a fluid and increasing the pressure in the milling device with the fluid to at least 0.2 of the Pᵣ and up to 1.25 Pᵣ of the fluid at from 0.5 to 1.5 of the Tᵣ of the fluid, where the fluid can behave as a supercritical fluid.

(c) milling to obtain a dispersion of pigment with polymeric dispersant. Alternatively an additional mixing step can result in an aqueous dispersion by mixing the pigment dispersion of step (c) into an aqueous medium.

The product of steps (a), (b) and (c) may be used in nonaqueous systems such as dispersed pigments for solvent containing paints.

The fluid used to pressurize the milling apparatus is capable acting as a supercritical fluid. Candidate fluids include carbon dioxide, methane, ethane, ethylene, propane propylene, butane, acetic acid, nitrous oxide, and ammonia. The most commonly used fluid is carbon dioxide which has a pure component critical point of 304.1° K and a critical pressure of 72.8 atm.

Pᵣ denotes the reduced pressure of the fluid and is the pressure of the system divided by the critical pressure of the pure component fluid. Tᵣ denotes the reduced temperature of the fluid and is the pressure of the system/the critical temperature of the pure component fluid. For instance, for pure carbon dioxide at its critical pressure and critical temperature would have a Pᵣ 1 at 72.8 atm and Tᵣ of 1 at 304.1° K. For a pressure of 36.4 atm and a temperature of 298° K the Pᵣ is 0.5 and the Tᵣ is 0.98. Both the Pᵣ and the Tᵣ are calculated based on the pure component fluid, not the mixture of the pure component fluid and the compatible solvent.

Compatible solvents will at least partially dissolve the dispersant and be miscible with the fluid which is added to the milling apparatus. The solvents. include but are not limited to lower alcohols, methanol, ethanol, 1-propanol, 2-propanol, butanol and other aliphatic alcohols; esters, methyl acetate, ethyl acetate, butyl acetate, alkyl carboxylic acid ester and other aliphatic esters; ketones, acetone, methyl ethyl ketone, methyl isobutyl ketone, cyclohexanone and other aliphatic ketones; ethers, diethyl ether, tetrahydrofuran, methyl tetrahydrofuran, dioxane,; lower acids such as acetic acid; amides such as dimethyl formamide, dimethylacetamide; aliphatic compounds such as pentane, hexane, cyclohexane, methyl cyclohexane and aromatic compounds, benzene, toluene, xylene, cumene and similar fluid compatible solvents.

### Pigments

A wide variety of organic and inorganic pigments, alone or in combination, may be used in the milling device. The term “pigment” as used herein means an insoluble colorant. The pigment particles are sufficiently small to permit free flow of the ink through the ink jet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is typically about 0.005 micron to about 15 micron. The pigment particle size should range from about 0.005 to about 5 micron and, optionally, from about 0.005 to about 1 micron. The average particle size as measured by dynamic light scattering is less than about 500 nm, optionally less than about 300 nm.

The selected pigment(s) may be used in dry or wet form. For example, pigments are usually manufactured in aqueous media and the resulting pigment is obtained as water-wet presscake. In presscake form, the pigment is not agglomerated to the extent that it is in dry form. Thus, pigments in water-wet presscake form do not require as much deflocculation in the process of preparing the inks as pigments in dry form. Representative commercial dry pigments are listed in U.S. Pat. No. 5,085,698.

The dispersant used to stabilize the pigment is a polymeric dispersant. Either structured or random polymers may be used, although structured polymers are commonly used as dispersants for reasons well known in the art. The term “structured polymer” means polymers having a block, branched or graft structure. Examples of structured polymers include AB or BAB block copolymers such as disclosed in U.S. Pat. No. 5,085,698; ABC block copolymers such as disclosed in EP-A-0556649; and graft polymers such as disclosed in U.S. Pat. No. 5,231,131. Other polymeric dispersants that can be used are described, for example, in U.S. Pat. No. 6,117,921, U.S. Pat. No. 6,262,152, U.S. Pat. No. 6,306,994 and U.S. Pat. No. 6,433,117. Random polymers are disclosed in U.S. Pat. No. 4,567,794. Polyurethane dispersants may also be used.

Polymer dispersants suitable for use in the present invention generally comprise both hydrophobic and hydrophilic monomers. Some examples of hydrophobic monomers used in random polymers are methyl methacrylate, n-butyl methacrylate, 2-ethylhexyl methacrylate, benzyl methacrylate, 2-phenylethyl methacrylate and the corresponding acrylates. Examples of hydrophilic monomers are methacrylic acid, acrylic acid, dimethylaminoethyl(meth)acrylate and salts thereof. Also quaternary salts of dimethylaminoethyl(meth)acrylate may be employed.

The polymeric dispersants based on (meth)acrylic acid as the hydrophilic group are often neutralized with basic materials when they are used in aqueous systems. When dimethylaminoethyl(meth)acrylate and the like are used the neutralization material is acidic.

Ionically stabilized dispersants (ISD) are disclosed in US2005/0090599 may also be useful with this fluid pressurization process. it has now been recognized that polymeric dispersants that function with virtually no steric stabilization can still successfully stabilize a dispersion. While the Ionically stabilized dispersant is normally low in ionic content, it is normally characterized by a salt stability test. A series of different concentration aqueous salt solutions (typically NaCl) are prepared. For each salt solution, approximately 1.5 ml (about 1.5 g) is added to a small glass vial.

For a pigment dispersion “concentrate”, one drop is added to the salt solution and gently mixed. For a pigment dispersion concentrate of about 15 wt % total solids (typical), one drop would typically be about 0.04 g total. The test for inks (which can be considered diluted forms of the concentrates) is very similar for the salt stability test for pigment dispersion concentrates, except that the solids content of inks is lower than that of a pigment dispersion concentrate, so the volume of ink added to the salt solution needs to be increased to maintain the same approximate amount of solids. Based on a typical ink of about 5 wt % total solids, about three times the weight of ink (as compared to concentrate) is needed.

Taking the case of the pigment dispersion concentrate mentioned above, the weight of solids from the concentrate would be about 0.006 g in about 1.5 g of the aqueous salt test solution, or about 0.4% by weight based on the weight of the aqueous salt test solution.

It should be noted that the 0.4% by weight number derived above is not critical for the application of the salt stability test, but can be used as a standard point if so desired. Because the results of the salt stability test are more related to the concentration of salt as compared to solids, and because it may be somewhat difficult to precisely determine the solids content of a pigment dispersion, for a standard of measurement the following convention will be adopted:
for pigment dispersions considered to be concentrates (about 10 wt % or more solids), one drop of dispersion should be used for 1.5 ml salt solution;
for more dilute pigment dispersions (such as inks having about 5 wt % solids or less), three drops of dispersion should be used for 1.5 ml salt solution; and
for pigment dispersions of an intermediate solids content (inks and/or concentrates of about 5-10 wt % solids), two drops of dispersion should be used for 1.5 ml salt solution.

Based on the above, the appropriate amount of the pigment dispersion is added to the salt solution and gently mixed. After sitting undisturbed for 24 hours at room temperature, sample stability is rated as follows:
Rating of 3: complete settling of pigment; transparent, uncolored liquid at top.
Rating of 2: no transparent uncolored liquid layer; definite settling onto bottom of vial observed when vial is tilted.
Rating of 1: no transparent uncolored liquid layer; very slight settling (small isolated spots) as observed during tilting of vial.
Rating of 0: no evidence of any settling.

The salt concentration where settling is definitely observed (a rating of 2 or 3) is taken as the critical flocculation concentration for the pigment dispersion. It can be inferred from this test that, with increasing critical flocculation concentration, the role of polymeric (steric) stabilization becomes more dominant and electrostatic stabilization becomes a less important stabilization mechanism.

The ISD polymer dispersants which can be used in the fluid pressurization dispersion process are rated at 2 or 3 at a concentration of salt of 0.2 molar. That is, ISD polymer dispersants, when associated with a pigment in an ISD, and when tested by the salt stability test, will be observed to precipitate from the test solution at 0.2 molar salt concentration. Rating criteria 2 and 3 will each meet the criteria of precipitation.

The salts for the aqueous salt solution used in the salt stability test are lithium, sodium or potassium salts, and normally sodium chloride is used.

### Dispersion Process

The process of preparing aqueous pigmented ink jet inks according to the present invention comprises the steps of:

(a) charging a milling device with mixture of a pigment, a polymeric dispersant and one or more compatible solvents,

(b) milling the mixture, while introducing into the milling device a fluid and increasing the pressure in the milling device with the fluid to at least 0.2 of the Pᵣ and up to 1.25 Pᵣ of the fluid at from 0.5 to 1.5 of the Tᵣ of the fluid, where the fluid can behave as a supercritical fluid

(c) milling to obtain a dispersion of pigment with polymeric dispersant,

(d) and alternatively mixing the pigment dispersion of step (c) into an aqueous medium, and

wherein both the Pᵣ and Tᵣ are calculated based only on the fluid

During step (a) the pigment, the polymeric dispersant and the suitable solvent are charged to the mill. The polymeric dispersant must be at least partially soluble in the solvent. The milling action may begin at anytime after the three components are in the mill. The polymeric dispersant may be neutralized at this stage in the process.

The second step consists of charging the fluid to the milling apparatus. This can be done by any convenient means including pressurizing from a higher pressure source, or pumping the fluid into the mill. The milling should continue during this pressurization step. If the mill does not permit milling during pressurization, the fluid may be added in aliquots, followed by milling. The addition of the fluid aliquots are continued until the desired pigment dispersion is accomplished.

The fluid pressurization is continued until a desired pressurization is obtained. The milling can be continued until the desired polymerically dispersed pigment is obtained. The time required for the milling may need to be determined by trial and error. Likely variables include the type of polymeric dispersant, the type of pigment, the compatible solvent, the fluid, temperature and pressure.

After the desired polymerically dispersed pigment is obtained, the fluid can be removed from the milling device by letting down the pressure through a valve or other device. The polymerically dispersed pigment is not depressurized rapidly as in a Rapid Expansion of Supercritical Solvents process. The milling apparatus may be further flushed with same fluid or a different fluid to remove the compatible solvent leaving behind the dispersed pigment. The dispersed pigment may be isolated from the milling apparatus or it may remain in the milling apparatus for the optional mixing into the aqueous carrier medium.

The polymerically dispersed pigment may be used for non aqueous applications without further processing.

In the same or different milling apparatus the optional aqueous carrier may be added and mixing done in the presence of the aqueous carrier medium. At this stage an optional dispersant neutralization agent may be added to the aqueous carrier medium. The amount of the neutralization agent may be from about 0.75 to 1.1 equivalents based on the ionic part in the polymeric dispersant. The neutralization agent may optionally be added at step (a).

While not being bound by theory, it is believed that as the fluid pressurizes the mill and dissolves in the solvent, the polymeric dispersant begins to interact with the pigment. This is facilitated by the active milling that is occurring during the pressurization of the milling apparatus. It is likely that the part of the polymeric dispersant that normally associates with the pigment starts that association leading to a polymerically dispersed pigment. It is possible that the when the fluid dissolves in the solvent the polymeric dispersant becomes less soluble in the solvent and is more attracted to the pigment surface.

The product of the milling step is relatively free of solvent and thus considerably increases formulation latitude in the final pigment dispersion and its subsequent use, especially in ink jet inks. Also, polymeric dispersants that are difficult to disperse in normally used aqueous dispersion process may be effective dispersants for pigments based on this fluid pressurization process.

The milling or dispersing process in step (a), (b), and (c) is understood to mean taking a pigment particle with a polymeric dispersant and processing it according to the steps described above to obtain a polymerically dispersed pigment which can be used as is or further mixed into an aqueous media.

The milling apparatus used for step (a), (b), and (c) of the process must be capable of operating at the required pressures that the fluid pressurization needs. Candidate mills include can be a media mill, a horizontal mini mill, a ball mill, an attritor, A high pressure media mill has been described in U.S. Pat. No. 7,152,819. This high pressure media mill is well suited for the inventive process. The media for the media mill is chosen from commonly available media, including zirconia, YTZ, and nylon. A mill set up with an ultrasonic device may also be used for step (a), (b) and (c) of the process.

The mixing apparatus for conversion into an aqueous media used for the optionally step (d) can be a media mill, a horizontal mini mill, a ball mill, an attritor a high speed disperser, or by passing the mixture through a plurality of nozzles within a liquid jet interaction chamber at a liquid pressure of at least 5,000 psi to produce a uniform dispersion of the pigment particles in the aqueous carrier medium (microfluidizer). The media for the media mill is chosen from commonly available media, including zirconia, YTZ, and nylon. These various mixing processes for step (d) are in a general sense well-known in the art, as exemplified by, U.S. Pat. No. 5,022,592, U.S. Pat. No. 5,026,427, U.S. Pat. No. 5,310,778, U.S. Pat. No. 5,891,231, U.S. Pat. No. 569,138, U.S. Pat. No. 5,976,232 and U.S. patent application Ser. No. 10/282,462 (filed 29 Oct. 2002).

In the case of organic pigments, the ink may contain up to approximately 30%, optionally about 0.1 to about 25%, and more optionally about 0.25 to about 10%, pigment by weight based on the total ink weight. If an inorganic pigment is selected, the ink will tend to contain higher weight percentages of pigment than with comparable inks employing organic pigment, and may be as high as about 75% in some cases, since inorganic pigments generally have higher specific gravities than organic pigments.

The polymer dispersant is normally present in the range of about 0.1 to about 20%, more optionally in the range of about 0.2 to about 10%, and still more optionally in the range of about 0.25% to about 5%, by weight based on the weight of the total ink composition.

### Aqueous Carrier Medium

The aqueous carrier medium for the optional step (d) is water or a mixture of water and at least one water-miscible organic solvent. Selection of a suitable mixture depends on requirements of the specific application, such as desired surface tension and viscosity, the selected pigment, drying time of the pigmented ink jet ink, and the type of paper onto which the ink will be printed. Representative examples of water-soluble organic solvents that may be selected include (1) alcohols, such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, di-ethylene glycol, triethylene glycol, propylene glycol, tetraethylene glycol, polyethylene glycol, glycerol, 2-methyl-2,4-pentanediol 1,2,6-hexanetriol and thiodiglycol; (6) lower alkyl mono- or di-ethers derived from alkylene glycols, such as ethylene glycol mono-methyl (or -ethyl) ether, diethylene glycol mono-methyl (or -ethyl)ether, propylene glycol mono-methyl (or -ethyl)ether, triethylene glycol mono-methyl (or -ethyl)ether and diethylene glycol di-methyl (or -ethyl)ether; (7) nitrogen containing cyclic compounds, such as pyrrolidone, N-methyl-2-pyrrolidone, and 1,3-dimethyl-2-imidazolidinone; and (8) sulfur-containing compounds such as dimethyl sulfoxide and tetramethylene sulfone.

A mixture of water and a polyhydric alcohol, such as diethylene glycol, are often used as the aqueous carrier medium. In the case of a mixture of water and diethylene glycol, the aqueous carrier medium usually contains from about 30% water/70% diethylene glycol to about 95% water/5% diethylene glycol. The preferred ratios are approximately 60% water/40% diethylene glycol to about 95% water/5% diethylene glycol. Percentages are based on the total weight of the aqueous carrier medium. A mixture of water and butyl carbitol is also an effective aqueous carrier medium.

The amount of aqueous carrier medium in the ink is typically in the range of about 70% to about 99.8%, and optionally about 80% to about 99.8%, based on total weight of the ink.

The aqueous carrier medium can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are optionally 1,2-C4-6 alkanediols. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and optionally about 0.2 to about 2%, based on the total weight of the ink.

### Other Additives

Other additives, such as biocides, humectants, chelating agents and viscosity modifiers, may be added to the ink for conventional purposes.

Biocides may be used to inhibit growth of microorganisms.

Inclusion of sequestering (or chelating) agents such as ethylenediamine-tetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Binders, if used, can be soluble or dispersed polymer(s). They can be any suitable polymer, for example, soluble polymers may include linear homopolymers, copolymers, block polymers or natural polymers. They also can be structured polymers including graft or branched polymers, stars, dendrimers, etc. The dispersed polymers can include latexes, polyurethane dispersions, etc. The polymers may be made by any known process including but not limited to free radical, group transfer, ionic, RAFT, condensation and other types of polymerization. Useful classes of polymers include, for example, acrylics, styrene-acrylics, poly-urethanes and alginates.

The following examples illustrate the invention without, however, being limited thereto.

### EXAMPLES

The process for preparing the aqueous pigment dispersions of the current invention was studied by using several pieces of equipment capable of withstanding the high pressures and temperatures required. In the case of using carbon dioxide which has a critical point of 31.1 C (or 304.1° K), and 78.8 atm the equipment needs to be capable of at least 150° and 1500 psig (˜100 atm).

To test the solubility of the polymeric dispersant in solvent while the fluid is pressurizing the system, a pressurizable cylinder with clear windows at each end is used. As the fluid gets pumped in the polymeric dispersant begins to come out of solution and an opaque solution is observed. For a Joncryl 611 (S C Johnson, Racine Wis.) which is a styrene acrylic polymeric dispersant dissolved in acetone, the pressure of carbon dioxide at which the polymer is observed to begin to come out of solution is shown in Table 1. The pressure is given in psig and the reduced pressure as if there is no other component beside the carbon dioxide fluid.

TABLE 1
Precipitation Pressure of Joncryl 611

| | Precipitation Pressure, | |
|---|---|---|
| Test Condition | psig, Pr | Polymer Wt. % |
| 1 | 410, 0.38 | 0.5 |
| 2 | 345, 0.32 | 0.5 |
| 3 | 365, 0.34 | 0.75 |
| 4 | 340, 0.32 | 1.00 |
| 5 | 290, 0.27 | 1.25 |
| 6 | 340, 0.32 | 1.5 |

In a similar test the random polymer Benzyl methacrylate/methacrylic acid as an 85/15 polymer was tested for solubility. At 2.5% concentration the precipitation pressure was 350 psig (0.32, reduced pressure) for an acetone solvent and 580 psig (0.58, reduced pressure) for a tetrahydrofuran solvent.

### Example 1

### Ultrasonic Disperser

The test apparatus is similar to the one shown in the drawing but the pressure vessel is a Jerguson Gauge and a ultrasonic processor is inserted from the bottom to provide the dispersing energy. The sonic processor is constructed such that it can be sealed to tolerate the pressures needed. An additional Jerguson Gauge is used as a recovery vessel. The pigment used was a carbon black, NIPEX™ 160, supplied by Degussa, Parsinappy N.J. The dispersant, pigment, and acetone were placed in the Jerguson Gauge milling vessel, the ultrasonic disperser turned on and carbon dioxide was fed to the Jerguson Gauge at 1 mL/min until a pressure of 1600 psig was reached. After milling, the system was flushed with pure carbon dioxide to remove excess acetone. The particles were collected in the second recovery vessel. The polymerically dispersed pigment particles were mixed into water and the particles size measured. The results for three different Joncryl dispersants are shown in Table 2

TABLE 2
Polymerically Dispersed Black Pigment

| | | | | | Final Particle Size in |
|---|---|---|---|---|---|
| | | Acid | | | Water (Number |
| Dispersion | Polymer | Number | MW | T | average) as d50 |
| 1 | Joncryl 678 | 215 | 8500 | 86 C. | 160 nm |
| 2 | Joncryl 568 | 108 | 4600 | 60 C. | 80 nm (2nd peak at 6 |
| | | | | | microns) |
| 3 | Joncryl 611 | 53 | 8100 | 50 C. | 100 nm 2nd peak at 2 |
| | | | | | microns |

### Example 2

### High Pressure Media Mill (HPMM) Disperser

A mixture in acetone with 10% pigment, a dispersant, Joncryl 611 at a Pigment/Dispersant ratio of 2.91 was put a beaker. The initial dispersion (approximately 200 g) was placed in a 500 ml glass beaker suspended in an ice bath to reduce evaporation. Agitation was provided by a Melton CM-100 Lab Disperser equipped with a 2″ sawtooth style high shear impeller; the dispersion was agitated at a setting of 2000-2500 RPM for 30 minutes.

Following the premix, approximately 425 ml (1570 g) of 0.5 mm yttria-stabilized zirconia (YTZ®) grinding beads were added to the HPMM (˜60% of the bulk volume within the HPMM). The premix dispersion was then fed to the HPMM, and the mixer was turned on (3400 RPM). Fifteen minutes later, the syringe pump was started at a carbon dioxide flow rate setting of 5 mL/min. The temperature within the HPMM was maintained between 33° C. and 39° C. The pressure within the HPMM rose steadily to reach 600 psi after 90 minutes of milling; the pressure then began to rise more rapidly, reaching nearly 1600 psi when the magnetic mixer and syringe pump were stopped after a total milling time of 120 minutes. This rapid rise in system pressure in the final minutes of the trial indicates that the liquid phase within the HPMM had expanded to occupy the entire internal volume of the system.

After the milling portion of the experiment was concluded, the particle recovery vessel was pressurized with carbon dioxide to approximately 1400 psi and the valve between the HPMM and the particle recovery vessel was opened. The syringe pump was then started at a flow rate of 25 mL/ml, and the system pressure was maintained at approximately 1300 psi using the back pressure regulator at the exit of the particle recovery vessel. There were initially two phases visible within the particle recovery vessel as the pigment dispersion flowed out of the HPMM: an acetone-rich liquid phase containing the encapsulated pigment particles, and a less dense supercritical carbon dioxide-rich phase. As carbon dioxide was added to the system, the liquid level within the particle recovery vessel rose steadily until it reached the top of the vessel. At this point the pigment particles were still largely suspended in the liquid phase; the particles were allowed to settle within the pressurized vessel, and the removal of acetone was continued. The system was flushed with carbon dioxide at a flow rate of 25 mL/min and a system pressure of approximately 1300 psi for two hours (˜1000 ml of carbon dioxide), and the valve at the exit of the particle recovery vessel was subsequently opened to vent the system to atmospheric pressure. Nearly 5 g of pigment particles were recovered from the particle recovery vessel as a dry powder.

The particles that remained in the HPMM after the high-pressure milling trial were removed by washing the grinding media with distilled water and subsequently filtering the resulting dispersion with a 0.45 micron filter. These particles were combined with 5 g of particles recovered from the particle recovery vessel, and distilled water was added to produce a dispersion with a volume of approximately 300 ml. Sodium hydroxide (0.21 g) was added to neutralize the dispersing polymer, and the mixture was agitated for 30 minutes at 2000-2200

RPM using a lab disperser. The pH of the dispersion at the end of this premix step was 9.85. The dispersion (281 g after some evaporation had occurred during the premix stage) was added to the HPMM along with 983 g of 0.3 mm YTZ® grinding media, and the media mill was operated at maximum RPM (3400) for approximately 90 minutes. The temperature within the HPMM was maintained between 31° C. and 33° C. during the milling process. After the magnetic mixer was stopped, 170 g of pigment dispersion was recovered from the HPMM. The pH of the dispersion was initially 7.7; several drops of concentrated sodium hydroxide solution were added to adjust the pH to 8.5

For Example 2 the d50 number average particle size was 65 and for another similar trial the particle size was 66.

The dispersion was next centrifuged on a Sorvall 6000 centrifuge at 1000 rpms for 30 minutes, to remove any large pigment particles. The resulting dispersion was then filtered through a 1.2 μm glass microfiber filter (Whatman GF/C cat. No. 1822090) three times to remove any other large particles.

The pigment content of the filtered dispersion was determined to be 3.16% by a UV/Vis spectrophotometer, using a black pigment dispersion with a known pigment content as a reference standard.

An ink was made using the filtered dispersion to contain 72.5 parts dispersion, 10 parts glycerol, 4 parts 1,2 hexanediol, 5 parts ethylene glycol, 0.5 parts Surfynol 465, and 3 parts 2-pyrrolidinone. The ink was then filtered through a 1.2 μm glass microfiber filter (Whatman GF/C cat. No. 1822090). The filtered ink had a pigment content of 1.75%.

An empty HP94 print head cartridge (HP C9350FN) was filled with approximately 15 g of the ink and inserted into an HP DeskJet 6540 printer. The ink was then printed onto Xerox 4200 and HP Multipurpose media at 100% area coverage, normal mode, black pen only, and let dry for 1 hour, to yield optical densities of 0.73 and 0.85 respectively. Optical density measurements were made with an X-Rite 500 Series Spectrodensitometer.

What is claimed is:

1. A method for preparing an aqueous pigmented ink jet ink comprising the steps of
(a) charging a milling device with a mixture of a pigment, a polymeric dispersant and one or more compatible solvents,
(b) milling the mixture, while introducing into the milling device a fluid and increasing the pressure in the milling device with the fluid to at least 0.2 of the Pᵣ and up to 1.5 Pᵣ of the fluid at from 0.5 to 1.5 of the Tᵣ of the fluid, where the fluid can behave as a supercritical fluid,
(c) milling to obtain a dispersion of pigment with polymeric dispersant, and wherein both the Pᵣ and Tᵣ are calculated based only on the fluid.

2. The method of claim 1 were there is an additional step (d) mixing the dispersion of the pigment of step (c) into an aqueous medium.

3. The method of claim 1 where the pressure is increased in the milling device with the fluid to at least 0.3 of the Pᵣ and up to 1.2 Pᵣ of the pure fluid.

4. The method of claim 1 where the pressure is increased in the milling device with the fluid to at least 0.45 of the Pᵣ and up to 0.8 Pᵣ of the pure fluid.

5. The method of claim 1 where the fluid is selected from carbon dioxide, methane, ethane, ethylene, propane, propylene, butane, acetic acid, nitrous oxide, and ammonia.

6. The method of claim 1 where the fluid is carbon dioxide.

7. The method of claim 1 where the polymeric dispersant is an structured or random polymer.

8. The method of claim 1 where the polymeric dispersant is an ionically stabilized dispersant.

9. The method of claim 1 where the polymeric dispersant is a polyurethane.

10. The method of claim 1 where the compatible solvent is selected from methanol, ethanol, 1-propanol, 2-propanol, butanol, methyl acetate, ethyl acetate, butyl acetate, acetone, methyl ethyl ketone, methyl isobutyl ketone, cyclohexanone, diethyl ether, tetrahydrofuran, methyl tetrahydrofuran, dioxane, dimethyl formamide, dimethylacetamide, pentane, hexane, cyclohexane, methyl cyclohexane, benzene, toluene, xylene, and cumene.

11. An aqueous pigmented ink jet ink of claim 1 comprising from 0.1 to 30 wt % pigment based on the total weight of the ink, a weight ratio of pigment to polymeric dispersant of from about 0.5 to about 6, a surface tension of 20 dyne/cm to 70 dyne/cm at 25° C., and a viscosity of lower than 30 cP at 25° C.

12. An aqueous pigmented ink jet ink of claim 1 comprising from 0.1 to 10 wt % pigment based on the total weight of the ink.

13. An ink set comprising at least one cyan ink, at least one magenta ink and at least one yellow ink, wherein at least one of the inks is an aqueous pigmented ink jet ink as set forth in claim 1.

14. A method for ink jet printing onto a substrate, comprising the steps of:
a. providing an ink jet printer that is responsive to digital data signals;
b. loading the printer with a substrate to be printed;
c. loading the printer with an ink as set forth in claim 11, and
d. printing onto the substrate using the ink in response to the digital data signals.

15. A method for ink jet printing onto a substrate, comprising the steps of:
a. providing an ink jet printer that is responsive to digital data signals;
b. loading the printer with a substrate to be printed;
c. loading the printer with an ink jet ink set as set forth in claim 13; and
d. printing onto the substrate using the inkjet ink set in response to the digital data signals.
